(19) United States
(12) Patent Application Publication
(10) Pub. No.: US 2024/0034038 A1
(43) Pub. Date: Feb. 1, 2024

(54) A SOL-GEL COATING TO GIVE COATED SUBSTRATES BARRIER PROPERTIES AND METHOD OF APPLICATIONS THEREOF

(71) Applicant: Manuel MILLIERY, PARIS (FR)

(72) Inventor: Manuel MILLIERY, PARIS (FR)

(21) Appl. No.: 18/254,959

(22) PCT Filed: Nov. 29, 2021
(86) PCT No.: PCT/EP2021/083400

§ 371 Date: May 30, 2023

(30) Foreign Application Priority Data
Nov. 27, 2020 (FR) 2012234
Mar. 29, 2021 (GB) 2104385.6

(51) Int. Cl. B32B 29/00; C09D 7/61; C09D 7/65; C09D 7/63; B32B 5/00; B32B 38/00; C09D 5/08

(52) U.S. Cl. CPC B32B 29/002; C09D 7/61; C09D 7/65; C09D 7/63; B32B 5/00; B32B 38/164; C09D 5/08; B32B 2038/166

(57) ABSTRACT

A coating and its application methods to coat at least one surface of a substrate, in particular cellulose-based substrates, and give it barrier properties to water, grease, oxygen, lights, moisture; heat resistance, a lower friction coefficient. The coating does not change the original properties of flexibility, biodegradability and recyclability of the original substrate. The coated substrate can be printed, can be recycled and exhibits unchanged properties in areas requiring folding of paper or cardboard.

### FIELD OF INVENTION

This invention relates to the field of barrier coating compositions featuring adhesion after polycondensation, finding use in single-use packaging, primary, secondary or tertiary packaging, single-use applications (cups, straws, forks, dishes, etc), food packages and wrappers including base paper and wrappers for chocolate and snacks, paper boxes and bags for fried potato, fried chicken, doughnuts, frozen food, pet food, crackers and cakes and wrappers for hamburgers and fried items, or for other non-food products such as belts, pens, paper, brushes, sponges, soaps, screws, telephones, plants, masks, and so on.

### BACKGROUND OF INVENTION

In the industrial sector there is a need to have a packaging product available for transporting CPG (Consumer Packaged Goods) such as for example fresh food (vegetables, meat, fruit, etc.), cooked food (products containing quantities of oily materials such as meat, etc.), baked goods, baked vegetables, fried food . . . ), sweets (candies, butts), tobacco products (RYO tobacco, cigarettes, cigars, . . . ), hygiene or beauty products (soaps, powders, lipsticks, . . . ) or household and hobby care products (sponges, screws, parts of household appliances, car parts).

For these uses plastic films as well as cellulosic composite substrates such as coated paper or parchment paper are well known in the art. Coated paper or parchment paper, generally consists of a sheet of paper laminated to a plastic film. In particular, these well-known cellulosic composites have a plastic film on the inner surface (i.e. the one in contact with food) and paper on the outer surface (i.e. the one in contact with the user's hand), which is often also coated with a paraffin or polymer of mostly oil origin. In this way, the cellulosic composite substrate avoids liquid leaking (water, oil . . . ) from the content of the package and protects the content from oxidation (oxygen barrier), moisture (losing moisture to the outside of the package or absorbing moisture from the outside of the package—water vapor barrier) or other contaminations (water, oil, . . . ).

Water- and oil-repellent paper sheets, comprising polymers, monomers or other plastics, are commonly utilized as food packages and wrappers for packaging or wrapping oily food items such as fried items and oil and fat-containing foods. These water- and oil-repellent paper sheets are not only desired to be fully water- and oil-repellent, but must also be safe.

A first important drawback is that the presence of the plastic film makes the product difficult to recycle without several separation processes leading to an important paper loss (also known as “coarse reject”).

Another drawback related to the difficult recycling of known cellulosic composites is the presence of adhesives between the plastic film and the paper. Furthermore, the presence of plastic precludes their use inside ovens of any type (electric, fuel, microwave).

Recently, water- and oil-repellent paper sheets having organic fluorine resins incorporated therein have been proposed as a solution to the above shortcomings. However, fluorinated organic compounds are a potential concern to the consumers' safety.

Sol-gel coatings have been proposed in order to overcome the above shortcomings. However, their application into thin coating films is currently feasible with high-energy demanding, and thus difficult to integrate in an industrial environment, techniques such as PVD/CVD (vapor deposition) and plasma beam deposition that are often incompatible with cellulose-based substrates.

Therefore, there is a substantial need to provide a safe, biodegradable, recyclable, and easy-to apply coating composition that overcomes the above technical obstacles.

In view of the experimental tests carried out by the author of the present invention, it is concluded that there are still opportunities for innovation in the development of nanoparticle-based coatings that allow better paper and cardboard properties. For example, it is desirable that the coatings after application do not affect the printing of the paper or cardboard and also include adhesion on the fins or areas that require bonding of the cardboard boxes obtained. It is also desirable that the coating improves more barriers than liquids, such as moisture vapor, oxygen, without preventing the recyclability or the biodegradability of the coated cellulosic support. From previous experiences with other products by the inventor, it has also been possible to verify that the use of metal oxides, such as silicon oxide without proper functionalization, requires greater anchoring, and it is also possible that they detach with the time causing its performance to be reduced while folding paper, heating paper, handling packaging, or even change the color of the substrate (i.e. yellowing).

To improve the performance of hydrophobic coatings and their moisture barrier properties on paper and cardboard, it is proposed in the present invention the use of silane-based compounds to improve dispersibility of said silicon oxide nanoparticles during application on the fibers of at least one surface of the paper or cardboard.

The Applicant has developed an advantageous coating composition that is safe, recyclable and easy-to apply such as for example by spraying and drying. Further advantageously, the coating composition according to the invention is printable and allows the folding of the coated substrate.

### SUMMARY

The invention relates to the use of a composition for coating a cellulose-comprising substrate, wherein the composition comprises:
A. at least one silane selected from the group consisting of: vinyltrimethoxysilane, methyltrimethoxysilane, trimethoxysilane, methyltriethoxysilane, triethoxypropylsilane, thriethoxysilane, (3-Mercaptopropyl)trimethoxysilane, (3-Mercaptopropyl)triethoxysilane, 3-(Trimethoxysilyl)propyl methacrylate, 3-(Triethoxysilyl)propyl methacrylate, Glycidoxypropyltrimethoxysilane, Bis[3-(triethoxysilyl)propyl] tetrasulfide, 1,2-bis(triethoxysilyl)ethane, N-[3-(trimethoxysilyl)propyl] aniline, Aminopropyltriethoxysilane, Bis-[3-(triethoxysilyl)propyl] amine, Bis-[3-(trimethoxysilyl)propyl] amine, Triethoxyphenylsilane and trimethoxyphenylsilane, Trimethoxyvinylsilane, Triethoxyvinylsilane, vinyltrimethylsilane, chlorovinylsilane, chlorodimethylvinylsilane and mixtures thereof,
B. from 0.01% to 3% by weight relative to the weight of the at least one silane of a catalyst selected from a monoprotic and/or a polyprotic acid,
and a dispersing agent selected from the group consisting of water and a hydroalcoholic solution comprising a linear or branched C1 to C4 alcohol and more than 55% by volume water relative to the volume of the dispersing agent.

In one embodiment, the at least one silane is selected from the group consisting of methyltriethoxysilane, methyltrimethoxysilane trimethoxysilane, triethoxysilane and mixtures thereof.

According to one embodiment, the monoprotic acid is selected from the group consisting of: hydrochloric acid, nitric acid and acetic acid, preferably the monoprotic acid is hydrochloric acid; and/or wherein the polyprotic acid is selected from the group consisting of: carbonic acid, sulfuric acid and citric acid.

The composition may further comprise at least one Lewis acid selected from the group consisting of: sulfur trioxide, aluminum chloride, iron (III) chloride and zinc chloride, preferably the Lewis acid is iron (III) chloride.

According to some embodiments, the composition further comprises:
C. from 0.30% to 50% by weight relative to the weight of the at least one silane of a filler composition comprising
   c1. at least one inorganic filler selected from the group consisting of silicon dioxide, aluminum oxides, phyllosilicates, inosilicates, tectosilicates, talcum powder, zinc sulphate, magnesium, oxide, zinc flakes, talc, kaolin, albarine, dolomite, cerium oxide, magnesium carbonate, calcium carbonate, sodium aluminate, calcium sulphate, barium sulphate, zinc stearate, and a mixture thereof; preferably the organic filler being silicon dioxide;
   and/or
   c2. at least one organic filler selected from the group consisting of cellulose, microfibrillated cellulose, nanofibrillated cellulose, cellulose microcrystals, starch, chitin or a mixture thereof, preferably selected from the group consisting of microfibrillated cellulose, nanofibrillated cellulose and a mixture thereof.

Optionally, the composition may further comprise from more than 0% to 1.5% by weight relative to the weight of the at least one silane of an organopolysiloxane (D) presenting alkyl chains with a number of carbon atoms C ranging from C7 to C18, and alkoxy groups.

According to another aspect, the invention relates to a coating composition, comprising:
A. at least one silane selected from the group consisting of: triethoxypropylsilane, methyltriethoxysilane, methyltrimethoxysilane, trimethoxysilane, triethoxysilane, and mixtures thereof,
B. from 0.01% to 3% by weight relative to the weight of the at least one silane of a catalyst selected from a monoprotic and/or a polyprotic acid, and a dispersing agent selected from the group consisting of water and a hydroalcoholic solution comprising a linear or branched C1 to C4 alcohol and more than 55% by weight water relative to the weight of the dispersing agent.

Such composition may further comprise:
C. from 0.30% to 10% by weight relative to the weight of the at least one silane of a filler composition comprising
   c1. an inorganic filler composition comprising at least one inorganic filler selected from the group consisting of silicon dioxide, aluminum oxides, phyllosilicates, inosilicates, tectosilicates, talcum powder, zinc sulphate, magnesium, oxide, zinc flakes, talc, kaolin, albarine, dolomite, cerium oxide, magnesium carbonate, calcium carbonate, sodium aluminate, calcium sulphate, barium sulphate, zinc stearate, and a mixture thereof;
   and/or
   c2. an organic filler composition comprising at least one organic filler selected from the group consisting of cellulose, microfibrillated cellulose, nanofibrillated cellulose, cellulose microcrystals, starch, chitin or a mixture thereof, preferably the organic filler being cellulose, preferably the organic filler being selected from the group consisting of microfibrillated cellulose, nanofibrillated cellulose and a mixture thereof.

According to one embodiment, the composition comprises:
A. at least one silane selected from the group consisting of: triethoxypropylsilane, methyltriethoxysilane, methyltrimethoxysilane, trimethoxysilane, triethoxysilane, in an amount ranging from 40% to 80% w/w in weight relative the total weight of the coating composition, and
B. a catalyst selected from a monoprotic and/or a polyprotic acid, in an amount ranging from 0.01% to 1% w/w in weight relative to the weight of the at least one silane.

According to another embodiment, the composition further comprises a filler composition (C) selected from:
c1. silicon dioxide in an amount ranging from 0.30% to 5.0% w/w in weight relative to the weight of the at least one silane, and/or
c2. microfibrillated and/or nanofibrillated cellulose in an amount ranging from 0.30% to 5.0% w/w in weight relative to the weight of the at least one silane.

The invention further relates to a composite coated article comprising:
a first layer consisting of a substrate selected from the group consisting of cellulose-comprising substrates, metals or plastic substrates, preferably cellulose-comprising substrates,
at least a second layer comprising the coating composition detailed herein above.

In one exemplary embodiment, the cellulose-comprising substrate is selected from the group consisting of: paper, treated paper, glassine paper, cardboard, cellulosic support, low-porous cellulosic support and wood.

The invention also relates to a method for coating a substrate, comprising the steps of:
a) providing a substrate selected among cellulose-comprising substrates, metals or plastic substrates,
b) preparing a coating composition according to the invention,
c) applying the coating composition on at least one surface of the substrate to obtain a preliminary composite coated article, and
d) drying the preliminary composite coated article at a temperature ranging from 20° C. for several days to 280° C. for less than 1 minute, to obtain the composite coated article.

Lastly, the invention relates to a method for preparing the coating composition according to the invention, said method comprising
i. dispersing components (A), (B) and optionally (C), as described above, in the dispersing agent to obtain a mixture, and
ii. stirring the mixture obtained from step (i) until a viscosity of 5-5000 cps is obtained and until room temperature is reached, to obtain a coating composition.

### DETAILED DESCRIPTION

According to a first aspect the invention relates to a coating composition, suitable for coating a substrate, comprising:
A. at least one silane, selected from the group consisting of: organosilanes such as organoalkoxysilanes, alkoxysilanes, alkylalkoxysilane, orthosilicates, silanetriols and mixtures thereof,
B. from 0.01% to 3% by weight relative to the weight of the at least one silane derivative of a catalyst selected from a monoprotic and/or a polyprotic acid, and
   a dispersing agent, wherein the dispersing agent is selected between water and an hydroalcoholic solution comprising water and a linear or branched C1 to C4 alcohol

In one embodiment, the coating composition may further comprise fillers of organic, or inorganic nature. Thus, in one embodiment, the coating composition further comprises:
C. from 0.30% to 50% by weight relative to the weight of the at least one silane derivative of a filler composition comprising
   c1. an inorganic filler composition comprising at least one inorganic filler selected from the group consisting of silicon dioxide, aluminum oxides, phyllosilicates, inosilicates, tectosilicates, talcum powder, zinc sulphate, magnesium, oxide, zinc flakes, talc, kaolin, albarine, dolomite, cerium oxide, magnesium carbonate, calcium carbonate, sodium aluminate, calcium sulphate, barium sulphate, zinc stearate, and a mixture thereof; preferably the organic filler being silicon dioxide;
   and/or
   c2. an organic filler composition comprising at least one organic filler selected from the group consisting of cellulose, microfibrillated cellulose, nanofibrillated cellulose, cellulose microcrystals, starch, chitin or a mixture thereof, preferably the organic filler being cellulose.

The at least one silane, selected from the group consisting of:
organoalkoxysilanes,
organosilane, typically selected from selected the group consisting of dimethylchlorosilane and 1, 2-Bis (chlorodimethylsilyl) ethane,
Alkoxysilanes or orthosilicates, typically selected from selected the group consisting of tetraethyl orthosilicate and tetramethyl orthosilicate,
alkylalkoxysilanes,
Silanetriol, typically 1-(3-mercaptopropyl)-silanetriol, and
mixtures thereof.

A relaxed composition is formed by hydrolyzing and crosslinking the silane (A). Typical silanes (A) are those cited below.

Preferably, the orthosilicates are selected between tetraethyl orthosilicate and tetramethyl orthosilicate.

Typically, the organosilanes are selected between dimethylchlorosilane and 1, 2-Bis (chlorodimethylsilyl) ethane.

Typically, the organoalkoxysilanes are selected from the group consisting of: Methyltriethoxysilane, Trimethoxymethylsilane, trimethylethoxysilane, Methoxy-trimethylsilane, (3-Mercaptopropyl)trimethoxysilane, (3-Mercaptopropyl)triethoxy-silane, 3-(Trimethoxysilyl)propyl methacrylate, 3(Triethoxysilyl)propyl methacrylate, Glycidoxypropyltrimethoxysilane, Bis[3(triethoxysilyl)propyl] tetrasulfide, 1,2-bis(triethoxysilyl)ethane, N-[3(trimethoxysilyl)propyl] aniline, Aminopropyl-triethoxysilane, Bis-[3(triethoxysilyl)propyl] amine, Bis-[3-(trimethoxysilyl)propyl]amine Triethoxyphenylsilane and trimethoxyphenylsilane.

Typically, the silanetriol is 1-(3-mercaptopropyl)-silanetriol

At least one silane may refer to one silane, a mixture of at least two silanes, a mixtures of three, or a mixture of four silanes. Typically, at least one silane refers to one silane or a mixture of a first silane and a second silane. In one embodiment, the at least one silane is at least one first silane and at least one second silane, the molar ratio of the at least one first to the at least one second silane being 1:1, 2:1, 3:1, 4:1 or 5:1.

### Silane (A)

In one embodiment, the at least one silane according to the invention presents one or two silane functions. In one embodiment, the at least one silane according to the invention presents one silane function

According to some embodiments, the at least one silane is selected from the group consisting of vinyltrimethoxysilane, methyltrimethoxysilane, trimethoxysilane, methyltriethoxysilane, triethoxypropylsilane, thriethoxysilane, (3-Mercaptopropyl)trimethoxysilane, (3-Mercaptopropyl)triethoxysilane, 3-(Trimethoxysilyl)propyl methacrylate, 3-(Triethoxysilyl)propyl methacrylate, Glycidoxypropyltrimethoxysilane, Bis[3-(triethoxysilyl)propyl] tetrasulfide, 1,2-bis(triethoxysilyl)ethane, N-[3-(trimethoxysilyl)propyl] aniline, Aminopropyltriethoxysilane, Bis-[3-(triethoxysilyl)propyl] amine, Bis-[3-(trimethoxysilyl)propyl] amine, Triethoxyphenylsilane, trimethoxyphenylsilane, Trimethoxyvinylsilane, Triethoxyvinylsilane, vinyltrimethylsilane, chlorovinylsilane, chlorodimethylvinylsilane and mixtures thereof.

According to one embodiment, the at least one silane is selected from the group consisting of vinyltrimethoxysilane, methyltrimethoxysilane, trimethoxysilane, methyltriethoxysilane, triethoxypropylsilane, thriethoxysilane, 3-(Trimethoxysilyl)propyl methacrylate, 3-(Triethoxysilyl)propyl methacrylate, Glycidoxypropyltrimethoxysilane, 1,2-bis(triethoxysilyl)ethane, N-[3-(trimethoxysilyl)propyl] aniline, Aminopropyltriethoxysilane, Bis-[3-(triethoxysilyl)propyl] amine, Bis-[3-(trimethoxysilyl)propyl] amine, Triethoxyphenylsilane, trimethoxyphenylsilane, Trimethoxyvinylsilane, Triethoxyvinylsilane, vinyltrimethylsilane, chlorovinylsilane, chlorodimethylvinylsilane and mixtures thereof.

According to a second embodiment, the at least one silane is selected from the group consisting of vinyltrimethoxysilane, methyltrimethoxysilane, trimethoxysilane, methyltriethoxysilane, triethoxypropylsilane, thriethoxysilane, (3-Mercaptopropyl)trimethoxysilane, (3-Mercaptopropyl)triethoxysilane, 3-(Trimethoxysilyl)propyl methacrylate, 3-(Triethoxysilyl)propyl methacrylate, Glycidoxypropyltrimethoxysilane, Bis[3-(triethoxysilyl)propyl] tetrasulfide, 1,2-bis(triethoxysilyl)ethane, Triethoxyphenylsilane, trimethoxyphenylsilane, Trimethoxyvinylsilane, Triethoxyvinylsilane, vinyltrimethylsilane, chlorovinylsilane, chlorodimethylvinylsilane and mixtures thereof.

According to a third embodiment, the at least one silane is selected from the group consisting of vinyltrimethoxysilane, methyltrimethoxysilane, trimethoxysilane, methyltriethoxysilane, triethoxypropylsilane, thriethoxysilane, 3-(Trimethoxysilyl)propyl methacrylate, 3-(Triethoxysilyl)propyl methacrylate, 1,2-bis(triethoxysilyl)ethane, Triethoxyphenylsilane trimethoxyphenylsilane, Trimethoxyvinylsilane, Triethoxyvinylsilane, vinyltrimethylsilane, chlorovinylsilane, chlorodimethylvinylsilane and mixtures thereof.

According to a fourth embodiment, the at least one silane is selected from the group consisting of vinyltrimethoxysilane, methyltrimethoxysilane, trimethoxysilane, methyltriethoxysilane, triethoxypropylsilane, thriethoxysilane, 3,1,2-bis(triethoxysilyl)ethane, Triethoxyphenylsilane trimethoxyphenylsilane, Trimethoxyvinylsilane, Triethoxyvinylsilane, vinyltrimethylsilane, chlorovinylsilane, chlorodimethylvinylsilane and mixtures thereof.

According to a fifth embodiment, the at least one silane is selected from the group consisting of methyltrimethoxysilane, trimethoxysilane, methyltriethoxysilane, triethoxypropylsilane, thriethoxysilane, 3,1,2-bis(triethoxysilyl)ethane, Triethoxyphenylsilane trimethoxyphenylsilane, and mixtures thereof.

According to a typical embodiment, the at least one silane is selected from the group consisting of methyltriethoxysilane, methyltrimethoxysilane trimethoxysilane, triethoxysilane and mixtures thereof.

According to a first variant the at least one silane is methyltriethoxysilane. According to a second variant the at least one silane is methyltriethoxysilane, thrimethoxysilane and/or triethoxysilane. According to a third variant the at least one first silane is methyltriethoxysilane, and the at least one second silane is triethoxysilane. According to a fourth variant the at least one silane is methyltrimethoxysilane. According to a fifth variant the at least one silane is methyltrimethoxysilane, thrimethoxysilane and/or triethoxysilane.

The at least one silane, as defined above, can be in an amount ranging from 50% to 90% in weight relative to the total weight of the composition. In one embodiment, the at least one silane is in an amount ranging from 40% to 80%, from 60% to 80% in weight relative to the total weight of the composition.

### Catalyst (B)

The catalyst (B) may be selected from a monoprotic acid, a polyprotic acid and a mixture thereof. In one embodiment, the monoprotic acid is selected from the group consisting of: hydrochloric acid, nitric acid and acetic acid. In one embodiment, the polyprotic acid is selected from the group consisting of carbonic acid, sulfuric acid and citric acid. In one specific embodiment, the catalyst is hydrochloric acid.

The catalyst (B) is present in an amount sufficient to catalyze the formation of hydroxyl groups, typically in an amount ranging from 0.01% to 3% by weight relative to the weight of the at least one silane.

In one embodiment, the catalyst, as defined above, is in an amount ranging from 0.01% to 2% by weight relative to the weight of the at least one silane. In one embodiment, the catalyst, as defined above, is in an amount ranging from 0.01% to 1% by weight relative to the weight of the at least one silane. In one embodiment, the catalyst, as defined above, is in an amount ranging from 0.01% to 1.5% by weight relative to the weight of the at least one silane. In one embodiment, the catalyst, as defined above, is in an amount ranging from 0.01% to 1% by weight relative to the weight of the at least one silane. In one embodiment, the catalyst, as defined above, is in an amount ranging from 0.01% to 0.5% by weight relative to the weight of the at least one silane. In one embodiment, the catalyst, as defined above, is in an amount ranging from 0.01% to 0.3% by weight relative to the weight of the at least one silane. In one embodiment, the catalyst, as defined above, is in an amount ranging from 0.01% to 0.05% by weight relative to the weight of the at least one silane.

In one specific embodiment, the catalyst is hydrochloric acid and is in an amount ranging from 0.01% to 1% by weight relative to the weight of the at least one silane. In one specific embodiment, the catalyst is hydrochloric acid and is in an amount ranging from 0.01% to 0.3% by weight relative to the weight of the at least one silane. In one specific embodiment, the catalyst is hydrochloric acid and is in an amount ranging from 0.01% to 0.05% by weight relative to the weight of the at least one silane.

The catalyst may be added as such into the composition or be diluted in a fraction of the dispersing agent as hereinafter described. In one embodiment, the catalyst, typically hydrochloric acid, is diluted in water.

### Dispersing Agent

One of the advantageous aspects of the invention is that the dispersing agent is an essentially aqueous medium. In one embodiment, the dispersing agent can be water or an hydroalcoholic solution comprising water and a linear or branched C1 to C4 alcohol.

In one embodiment, the dispersing agent is water.

In one embodiment, the dispersing agent is an hydroalcoholic solution comprising water and a linear or branched C1 to C4 alcohol.

The linear or branched C1 to C4 alcohol may be selected from the group consisting of methanol, ethanol, propanol, isopropanol, n-butanol, and tert-butanol. In one embodiment, the linear or branched C1 to C4 alcohol is selected from the group consisting of methanol, ethanol, isopropanol, and a mixture thereof. In one embodiment, the linear or branched C1 to C4 alcohol is a linear C1 to C4 alcohol selected from the group consisting of methanol, ethanol, and a mixture thereof. In one specific embodiment, the linear or branched C1 to C4 alcohol is ethanol.

Typically, the hydroalcoholic solution comprises water in an amount more than 50% in volume relative to the volume of the dispersing agent. In one embodiment, the dispersing agent is an hydroalcoholic solution comprising a linear or branched C1 to C4 alcohol and more than 55% by volume water relative to the volume of the dispersing agent.

In one embodiment, the dispersing agent according to any one of the above embodiments is in an amount ranging from 5% to 60% in weight relative to the total weight of the composition. In one embodiment, the dispersing agent according to any one of the above embodiments is in an amount ranging from 10% to 50% in weight relative to the total weight of the composition. In one embodiment, the dispersing agent according to any one of the above embodiments is in an amount ranging from 15% to 40% in weight relative to the total weight of the composition. In one embodiment, the dispersing agent according to any one of the above embodiments is in an amount ranging from 20% to 30% in weight relative to the total weight of the composition.

According to an optional embodiment, the composition comprises at least one Lewis acid selected from the group consisting of: sulfur trioxide, aluminum chloride, iron (III) chloride and zinc chloride. In one embodiment, the Lewis acid is iron (III) chloride. In one embodiment, the at least one Lewis acid is in an amount of from about 0.01% to about 3% by weight of the silane compound, more preferably from about 0.02% to about 2% by weight of the silane compound.

According to some embodiments, the composition further comprises from 0.30% to 50% by weight relative to the weight of the at least one silane of a filler composition (C) selected from the group consisting of at least one inorganic filler (c1), at least one organic filler (c2) and a mixture thereof.

Inorganic filler (C1)

The at least one inorganic filler (c1) may be selected from the group consisting of silicon dioxide, aluminum oxides, phyllosilicates, inosilicates, tectosilicates, talcum powder, zinc sulphate, magnesium, oxide, zinc flakes, talc, kaolin, albarine, dolomite, cerium oxide, magnesium carbonate, calcium carbonate, sodium aluminate, calcium sulphate, barium sulphate, zinc stearate, and a mixture thereof.

In one embodiment, the at least one inorganic filler is selected from the group consisting of silicon dioxide, aluminum oxides, talcum powder, zinc sulphate, magnesium, oxide, zinc flakes, talc, kaolin, albarine, dolomite, cerium oxide, magnesium carbonate, calcium carbonate, sodium aluminate, calcium sulphate, barium sulphate, zinc stearate, and a mixture thereof.

In one specific embodiment, the inorganic filler is silicon dioxide (silica). In one embodiment, the inorganic filler is in the form of microparticles, typically presenting an average diameter ranging from 1 to 100 micrometers (μm). In one embodiment, the inorganic filler, in particular silica, is in the form of nanoparticles, typically presenting an average diameter ranging from 1 to 100 nanometers (nm). In one embodiment, the silica nanoparticles present surface area ranging from about 90 to about 130 m²/g. In a yet specific embodiment, the silica nanoparticles are fumed silica.

According to one embodiment, the at least one inorganic filler, typically silica, is in an amount ranging from 0.30% to 50%, from 0.30 to 30% by weight relative to the weight of the at least one silane. In one embodiment, the at least one inorganic filler, typically silica, is in an amount ranging from 0.30% to 10%, from 0.30% to 5%, from 0.50% to 5%, from 1% to 5% by weight relative to the weight of the at least one silane. In one embodiment, the at least one inorganic filler, typically silica, is in an amount ranging from 0.5% to 3%, from 1% to 3%, from 1.5% to 3% by weight relative to the weight of the at least one silane.

In one embodiment, the molar ratio of the at least one silane to the dispersing agent to the inorganic filler ranges from 20/10/1 to 20/9/2. In one embodiment, the molar ratio of the at least one silane to the dispersing agent; selected from water, to the inorganic filler, selected from silica, ranges from 20/10/1 to 20/9/2.

The at least one inorganic filler, typically silica, may be in the form of a powder or a suspension, typically in the dispersing agent according to the invention, preferably water. In one embodiment, when the that when the at least one inorganic filler, typically silica, is in the form of a powder or a suspension, the amounts of said at least one inorganic filler refer to the amount expressed as a dry weight relative to the dry weight of the at least one silane.

In one embodiment, the at least one inorganic filler, typically silica particles, is in the form of a suspension in water. In one embodiment, the at least one inorganic filler, are silica nanoparticles, is in the form of a colloidal suspension in water.

Organic filler (C2)

The at least one organic filler (c2) may be selected from the group consisting of cellulose, microfibrillated cellulose, nanofibrillated cellulose, cellulose microcrystals, starch, chitin or a mixture thereof.

In one embodiment, the at least one organic filler is selected from the group consisting of cellulose, microfibrillated cellulose, nanofibrillated cellulose, cellulose microcrystals, and a mixture thereof.

According to a first embodiment, the at least one organic filler is microfibrillated cellulose. According to a second, the at least one organic filler is nanofibrillated cellulose. Microfibrillated cellulose (MFC) and nanofibrillated cellulose (NFC) can be prepared from any cellulose-source material, such as wood-pulp. The micro or nanocellulose fibrils may be isolated from the cellulose-source material fibers using mechanical methods which expose the pulp to high shear forces, ripping the larger wood-fibers apart into microfibers or nanofibers respectively. For this purpose, any high shear force applying means known int the art can be applied such as for example high-pressure homogenizers, grinders or microfluidizers in order to delaminate the cell walls of the fibers and liberate the nanosized fibrils. MCF and NFC are commercially available organic fillers.

According to one embodiment, the at least one organic filler, typically selected from the group consisting of cellulose, microfibrillated cellulose, nanofibrillated cellulose, cellulose microcrystals, and a mixture thereof, is in an amount ranging from 0.20% to 50% or from 0.30 to 50% by weight relative to the weight of the at least one silane. In one embodiment, the at least one organic filler, typically selected from the group consisting of microfibrillated cellulose, nanofibrillated cellulose, and a mixture thereof, is in an amount ranging from 0.30% to 10%, from 0.30% to 5%, from 0.3% to 1%, from 1% to 5% by weight relative to the weight of the at least one silane. In one specific embodiment, the at least one organic filler, typically microfibrillated cellulose, is in an amount ranging from 0.2% to 3%, from 0.2% to 1%, from 0.3% to 0.5% by weight relative to the weight of the at least one silane.

According to an optional embodiment, the composition further comprises an additional siloxane that is selected from organopolysiloxanes (D) presenting substituted with alkyl chains with a number of carbon atoms C ranging from C7 to C18, and alkoxy groups, in an amount ranging from more than 0% to 1.5% by weight relative to the weight of the at least one silane. In one embodiment, the organopolysiloxane (D) presents at least two silane moieties, at least three silane moieties or at least four silane moieties. Preferably, the chemical structure of component (D) is free of hydroxyl groups.

In one embodiment, the composition may optionally comprise a colorant such as, among others, a UV or IR absorbing dye.

In one embodiment, the composition is in the form selected from the group consisting of solution, emulsion and dispersion. In one embodiment, the composition is in the form of emulsion.

In one embodiment, the composition comprises or consists of:
A. at least one silane selected from the group consisting of: vinyltrimethoxysilane, methyltrimethoxysilane, trimethoxysilane, methyltriethoxysilane, triethoxypropylsilane, thriethoxysilane, (3-Mercaptopropyl)trimethoxysilane, (3-Mercaptopropyl)triethoxysilane, 3-(Trimethoxysilyl)propyl methacrylate, 3-(Triethoxysilyl)propyl methacrylate, Glycidoxypropyltrimethoxysilane, Bis[3-(triethoxysilyl)propyl] tetrasulfide, 1,2-bis(triethoxysilyl)ethane, N-[3-(trimethoxysilyl)propyl] aniline, Aminopropyltriethoxysilane, Bis-[3-(triethoxysilyl)propyl] amine, Bis-[3-(trimethoxysilyl)propyl] amine, Triethoxyphenylsilane and trimethoxyphenylsilane, Trimethoxyvinylsilane, Triethoxyvinylsilane, vinyltrimethylsilane, chlorovinylsilane, chlorodimethylvinylsilane and mixtures thereof,
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane
   and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
A. at least one silane selected from the group consisting of vinyltrimethoxysilane, methyltrimethoxysilane, trimethoxysilane, methyltriethoxysilane, triethoxypropylsilane, thriethoxysilane, 3-(Trimethoxysilyl)propyl methacrylate, 3-(Triethoxysilyl)propyl methacrylate, Glycidoxypropyl-trimethoxysilane, 1,2-bis(triethoxysilyl)ethane, N-[3-(trimethoxysilyl)propyl]aniline, Aminopropyltriethoxysilane, Bis-[3-(triethoxysilyl)propyl] amine, Bis-[3-(trimethoxysilyl)propyl] amine, Triethoxyphenylsilane, trimethoxyphenylsilane, Trimethoxyvinylsilane, Triethoxyvinylsilane, vinyltrimethylsilane, chlorovinylsilane, chlorodimethylvinylsilane and mixtures thereof.
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane
   and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
A. at least one silane selected from the group consisting of vinyltrimethoxysilane, methyltrimethoxysilane, trimethoxysilane, methyltriethoxysilane, triethoxypropylsilane, thriethoxysilane, 3-(Trimethoxysilyl)propyl methacrylate, 3-(Triethoxysilyl)propyl methacrylate, 1,2-bis(triethoxysilyl)ethane, Triethoxyphenylsilane trimethoxyphenylsilane, Trimethoxyvinylsilane, Triethoxyvinylsilane, vinyltrimethylsilane, chlorovinylsilane, chlorodimethylvinylsilane and mixtures thereof.
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane
   and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
A. at least one silane selected from the group consisting of methyltrimethoxysilane, trimethoxysilane, methyltriethoxysilane, triethoxypropylsilane, thriethoxysilane, 3,1,2-bis(triethoxysilyl)ethane, Triethoxyphenylsilane trimethoxyphenylsilane, and mixtures thereof.
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane
   and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
A. at least one silane selected from the group consisting of methyltriethoxysilane, methyltrimethoxysilane trimethoxysilane, triethoxysilane and mixtures thereof and mixtures thereof.
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
A. at least one silane selected from the group consisting of: vinyltrimethoxysilane, methyltrimethoxysilane, trimethoxysilane, methyltriethoxysilane, triethoxypropylsilane, thriethoxysilane, (3-Mercaptopropyl)trimethoxysilane, (3-Mercaptopropyl)triethoxysilane, 3-(Trimethoxysilyl)propyl methacrylate, 3-(Triethoxysilyl)propyl methacrylate, Glycidoxypropyltrimethoxysilane, Bis[3-(triethoxysilyl)propyl] tetrasulfide, 1,2-bis(triethoxysilyl)ethane, N-[3-(trimethoxysilyl)propyl] aniline, Aminopropyltriethoxysilane, Bis-[3-(triethoxysilyl)propyl] amine, Bis-[3-(trimethoxysilyl)propyl] amine, Triethoxyphenylsilane and trimethoxyphenylsilane, Trimethoxyvinylsilane, Triethoxyvinylsilane, vinyltrimethylsilane, chlorovinylsilane, chlorodimethylvinylsilane and mixtures thereof,
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane
C. from 0.30% to 50% by weight relative to the weight of the at least one silane of a filler composition comprising
   c1. at least one inorganic filler selected from the group consisting of silicon dioxide, aluminum oxides, phyllosilicates, inosilicates, tectosilicates, talcum powder, zinc sulphate, magnesium, oxide, zinc flakes, talc, kaolin, albarine, dolomite, cerium oxide, magnesium carbonate, calcium carbonate, sodium aluminate, calcium sulphate, barium sulphate, zinc stearate, and a mixture thereof; preferably the organic filler being silicon dioxide;
   and/or
   c2. at least one organic filler selected from the group consisting of cellulose, microfibrillated cellulose, nanofibrillated cellulose, cellulose microcrystals, starch, chitin or a mixture thereof.
      and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
A. at least one silane selected from the group consisting of vinyltrimethoxysilane, methyltrimethoxysilane, trimethoxysilane, methyltriethoxysilane, triethoxypropylsilane, thriethoxysilane, 3-(Trimethoxysilyl)propyl methacrylate, 3-(Triethoxysilyl)propyl methacrylate, Glycidoxypropyltrimethoxysilane, 1,2-bis(triethoxysilyl)ethane, N-[3-(trimethoxysilyl)propyl] aniline, Aminopropyltriethoxysilane, Bis-[3-(triethoxysilyl)propyl] amine, Bis-[3-(trimethoxysilyl)propyl] amine, Triethoxyphenylsilane, trimethoxyphenylsilane, Trimethoxyvinylsilane, Triethoxyvinylsilane, vinyltrimethylsilane, chlorovinylsilane, chlorodimethylvinylsilane and mixtures thereof.
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane
C. from 0.30% to 10% by weight relative to the weight of the at least one silane of a filler composition comprising
   c1. at least one inorganic filler selected from the group consisting of silicon dioxide, aluminum oxides, phyllosilicates, inosilicates, tectosilicates, talcum powder, zinc sulphate, magnesium, oxide, zinc flakes, talc, kaolin, albarine, dolomite, cerium oxide, magnesium carbonate, calcium carbonate, sodium aluminate, calcium sulphate, barium sulphate, zinc stearate, and a mixture thereof; preferably the organic filler being silicon dioxide;
   and/or
   c2. at least one organic filler selected from the group consisting of cellulose, microfibrillated cellulose, nanofibrillated cellulose, cellulose microcrystals, starch, chitin or a mixture thereof.
      and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
A. at least one silane selected from the group consisting of vinyltrimethoxysilane, methyltrimethoxysilane, trimethoxysilane, methyltriethoxysilane, triethoxypropylsilane, thriethoxysilane, 3-(Trimethoxysilyl)propyl methacrylate, 3-(Triethoxysilyl)propyl methacrylate, 1,2-bis(triethoxy-silyl)ethane, Triethoxyphenylsilane trimethoxyphenylsilane, Trimethoxyvinylsilane, Triethoxyvinylsilane, vinyltrimethylsilane, chlorovinylsilane, chlorodimethylvinylsilane and mixtures thereof.
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane;
c1. from 0.5% to 3%, from 1% to 3%, from 1.5% to 3% by weight relative to the weight of the at least one silane of silicon dioxide;
and/or
c2. from 0.30% to 10%, from 0.30% to 5%, from 0.3% to 1%, from 1% to 5% by weight relative to the weight of the at least one silane of at least one organic filler, typically selected from the group consisting of microfibrillated cellulose, nanofibrillated cellulose, and a mixture thereof.
   and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
A. at least one silane selected from the group consisting of methyltrimethoxysilane, trimethoxysilane, methyltriethoxysilane, triethoxypropylsilane, thriethoxysilane, 3,1,2-bis(triethoxysilyl)ethane, Triethoxyphenylsilane trimethoxyphenylsilane, and mixtures thereof.
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane;
c1. from 0.5% to 3%, from 1% to 3%, from 1.5% to 3% by weight relative to the weight of the at least one silane of silicon dioxide;
   and/or
c2. from 0.30% to 10%, from 0.30% to 5%, from 0.3% to 1%, from 1% to 5% by weight relative to the weight of the at least one silane of at least one organic filler, typically selected from the group consisting of microfibrillated cellulose, nanofibrillated cellulose, and a mixture thereof.
   and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
A. at least one silane selected from the group consisting of methyltriethoxysilane, methyltrimethoxysilane trimethoxysilane, triethoxysilane and mixtures thereof and mixtures thereof.
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane;
c1. from 0.5% to 3%, from 1% to 3%, from 1.5% to 3% by weight relative to the weight of the at least one silane of silicon dioxide;
   and/or
c2. from 0.30% to 10%, from 0.30% to 5%, from 0.3% to 1%, from 1% to 5% by weight relative to the weight of the at least one silane of at least one organic filler, typically selected from the group consisting of microfibrillated cellulose, nanofibrillated cellulose, and a mixture thereof;
   and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
C. at least one silane selected from the group consisting of methyltriethoxysilane, methyltrimethoxysilane, trimethoxysilane, triethoxysilane and mixtures thereof.
D. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane;
c1. silicon dioxide in an amount ranging from 0.30% to 5.0% w/w in weight relative to the to the weight of the at least one silane,
   and/or
c2 microfibrillated or nanofibrillated cellulose in an amount ranging from 0.30% to 5.0% w/w in weight relative to the weight of the at least one silane,
   and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
A. at least one silane selected from the group consisting of methyltriethoxysilane, and methyltrimethoxysilane thereof and mixtures thereof.
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane;
c1. silicon dioxide in an amount ranging from 0.30% to 5.0% w/w in weight relative to the weight of the at least one silane, and/or
c2 microfibrillated or nanofibrillated cellulose in an amount ranging from 0.30% to 5.0% w/w in weight relative to the weight of the at least one silane,
   and a dispersing agent selected from the group consisting of water and a hydroalcoholic solution comprising a linear or branched C1 to C4 alcohol and more than 55% by volume water relative to the volume of the dispersing agent.

In one embodiment, the composition comprises or consists of:
A. a first silane selected from the group consisting of methyltriethoxysilane, and methyltrimethoxysilane and a second silane selected from the group consisting of trimethoxysilane, triethoxysilane.
B. from 0.01% to 3% by weight relative to the weight of the at least one silane of a catalyst selected from a monoprotic and/or a polyprotic acid, preferably the catalyst being hydrochloric acid in an amount ranging from 0.01% to 1% by weight relative to the weight of the at least one silane;
c1. silicon dioxide in an amount ranging from 0.30% to 5.0% w/w in weight relative to the weight of the at least one silane,
   and/or
c2 microfibrillated or nanofibrillated cellulose in an amount ranging from 0.30% to 5.0% w/w in weight relative to the weight of the at least one silane, and a dispersing agent selected from the group consisting of water and a hydroalcoholic solution comprising a linear or branched C1 to C4 alcohol and more than 55% by volume water relative to the volume of the dispersing agent.

Advantageously, the present composition is biodegradable and recyclable given the absence of non-biodegradable and/or non-recyclable polymers. In one embodiment, the composition does not comprise plastic polymers. In one embodiment, the composition does not comprise polyalkylene, polyacrylate, polymethyl acrylate, polyester, polyamide, polyurethane, polyvinylarylene, polyvinyl ester, polyvinylene/alkylene copolymer, polyalkylene oxide or combinations thereof. In one embodiment, the composition does not comprise latex. In one embodiment, the composition does not comprise biodegradable plastics such as polyhydroxyalcanoate or polylactic acid.

Use of the composition for coating a substrate

According to a second aspect, the invention relates to the use of the composition as described in any one of the above embodiments for coating a substrate.

For the purposes of the present application, the substrate is meant to be the one to be coated with such coating composition. In one embodiment, substrates suitable to be coated with the coating composition are selected from the group consisting of: cellulose-comprising or cellulose-based substrates, metals and plastics substrates. By cellulose-based substrates refer to substrates essentially consisting of cellulose, or comprising more than 70%, more than 80% cellulose in weight relative to the substrate's weight.

In one embodiment, the cellulose-comprising or cellulose-based substrates are selected from the group consisting of: paper, treated paper, glassine paper, cardboard, cellulosic support, low-porous cellulosic support and wood. In one embodiment, the cellulose-comprising or cellulose-based substrates are selected from the group consisting of: paper, treated paper, and cardboard.

The coating treatment with the inventive coating composition provides a uniform coating with almost no variations.

When a cellulose-comprising substrate, such as paper or cardboard, is treated with the composition, the resultant coating imparts water repellency, water-proof, grease-proof and improves by at least 30% other barriers such as oxygen barrier, water vapor barrier and, possibly, light barriers (UV, IR).

According to a preferred embodiment, the cellulose-based substrate of the composite coated article is paper. Such a paper advantageously results in a water- and oil-repellent sheet having fold resistance, comprising:
a first layer of paper;
at least a second layer, adherent to the first layer, consisting of the coating composition.

For said preferred embodiment, the advantage of this coating composition on paper is that is particularly flexible and its barrier properties, such those illustrated, remain the same even after an eventual folding of the paper.

The metals are preferably selected among metals in passive conditions, where the metal surface is protected by an oxide film.

For example, suitable metals for the aim of the invention are selected among iron, ferrous steels or aluminum.

Preferably, when the substrate is a metal from those listed above, preferably aluminum, the pH of the coating composition can be adapted to be able to oxidize such metal and suitably stick onto it. For this purpose, the preferred range of pH for the coating composition ranges between 2 and 4.

The plastic substrates are preferably selected among polyesters, such as poilycarbonate (PC), polyethylene terephthalate (PET), and polyvinylchloride (PVC).

The coating resulting from the coating composition is preferably fully adherent to such substrates such as cellulose-based, metals or plastic substrates.

Preferably, such a use is enabled by means of the application method herein described.

### Coating Method

Thus, according to a third aspect, the invention relates to a method for coating a substrate, comprising the steps of:
a) providing a substrate as defined above,
b) supplying a coating composition according to any one of the above embodiments,
c) applying the coating composition on at least one surface of the substrate to obtain a preliminary composite coated article, and
d) drying the preliminary composite coated article at a temperature ranging from 20° C. for several days to 280° C. for less than 1 minute, to obtain the composite coated article.

The solution of the coating composition is coated down onto a substrate.

Once applied on the substrate to obtain the composite coated article, said coating composition turns into a hydrogel. Particularly, once applied on the substrate, said solution of the coating composition is dried. The drying is effective to evaporate and substantially remove the dispersing agent, typically water if applicable the linear or branched C1 to C4 alcohol.

The drying step is essential for the condensation and curing of the sol, turning it into a crosslinked gel or hydrogel with the substrate, preferably with the polymer of the substrate, such as the cellulose. In one embodiment, the combination of the hydroxyl groups between the substrate and the coating composition and the subsequent hydrolysis, induced by drying, creates the reticulation between the substrate and such coating composition, preferably the paper and the silica. In the preferred embodiment, the drying is conducted at temperatures compatible with paper substrates, and may range from about 20° C. to about 280° C., depending on economical drying times, preferably from about 100° C. to about 200° C., preferably at 180° C.

For the scope of the present invention, the surface (or side) refers to the surface (or side) that is to be coated with the coating composition.

Once the sol of the coating composition has reticulated, the composite coated article, coated on at least one surface (or side), has an oxygen transmission rate of less than at least 80%, preferably about 20% than that of the uncoated substrate. Preferably the composite coated article has an oxygen transmission rate of less than about 1500 cm³/m²/day as calculated by ASTM D-3985.

The substrate is coated with a substantially uniform coating of the relaxed coating composition at a thickness not in excess of that which would provide a substantially crack-free layer on the substrate when dried. Once the coating composition has dried, the relaxed polymer coating composition obtained provides a substantially crack-free layer on the substrate.

Preferably, the amount of the coating composition applied on step (c) is suitable for obtaining a dry coating weight of at least 2.0 g/m², in order to obtain a water- and oil-repellent, gas barrier, light barrier, coating layer.

The dried, substantially uniform coating composition spread on preferably the cellulose-based substrate is one which is substantially crack free and has a preferred thickness of about 10 μm or less, preferably 0.3 μm or less, depending mostly on the presence of particles or not.

This coating method ensures an effective oxygen barrier and water vapor barrier coating at room temperature, a strong heating or flame resistance, empowering paper, cardboard or other cellulosic support to repel water and oil. This invention stands out from the previous ones, because the coating composition, the sol, and the application procedures do not affect the printing of paper or cardboard, the foldability or the recyclability of the cellulosic support. Moreover, this invention stands out from the previous ones, because the coating composition, the sol, and the application procedures do not affect the biodegradability of the original substrate since preferably the only non-cellulosic component on the final coated item is silica dioxide.

According to a preferred embodiment, the substrate can be coated on just one of its major surfaces; in particular, when a cellulose-comprising substrate is selected, preferably paper, having a thickness≤188 μm, preferably ranging from 160 μm to 188 μm, the coating composition is applied to one of the major surfaces of the substrate only. In this way, the coating composition allows to achieve a water- and oil-repellency also on the edge side, preforming on the cutting line as well as on the planar side.

The thickness described here above is illustrative and not limited to the range of 160 μm to 188 μm because it is extremely related to the porosity of the material, the specific surface and relative humidity of the substrate, among other factors.

According to an alternative embodiment, the coated article is coated on both its major surfaces; in particular, when a cellulose-based substrate is selected, preferably paper, having a thickness>188 μm and up to 900 μm, the coating composition is applied to both the major surfaces (or sides) of the substrate. The double side coating allows the section, the edge side of the paper, to maintain a mostly uniform coating and so barrier properties. For a preferred embodiment of the invention and in particular for cardboards with thicknesses higher than 900 μm the coating should also be applied on the edges to achieve the technical effect described above.

According to a preferred embodiment, said application method is preferably for preparing a water- and oil-repellent cellulose-based substrate, preferably paper, with important barriers against water vapor and oxygen. Preferably, the substrate is paper.

The paper substrate is preferably selected from among kraft paper, wood-free paper, paper board, liner, glassine paper, recycled paper, MFC coated paper and parchment paper.

The application method allows to produce new composite coated articles which are easy to print with current coating or printing machines such as, for example, rotogravure or Flexography or on sizing section on papermaking machines or less common paper coating techniques, like direct spraying. This is possible thanks to the coating composition, whose viscosity properties can be tuned between 5 and 5000 cps (ASTM D445), by varying for example the size of nanosized silica and/or the quantity of nanosized silica and/or the kind and molar ratio of the at least one silane and/or inorganic or organic particles as surfactants.

On another embodiment this invention gives new methods to apply, in a special effective way, this coating composition based preferably on silica and made with technology, like spraying or replacing the starch bath in the size press or other coating techniques on papermaking or coating machines including the less common direct spray coating in the same section of the papermaking machine.

In both cases the substrate, preferably cellulose-based substrates, even more preferably paper, is empowered with important barrier properties against water, grease, oxygen, water vapor, moisture, light or UV radiations added to high resistance to heating while keeping the biodegradability and recyclability of the original uncoated substrate. All this without heavy metals or plastic polymers, thanks to both the based coating composition and the application methods described above.

The advantage of applying the above-mentioned coating composition for preferably papermaking machines is about the high temperature of the drying paper (around 60° C.), improving the reticulation of the sol as described here below.

The substrate can be coated with a printing machine, such as, for example, rotogravure machines by applying preferably about 10 g/m² to 30 g/m² of wet product, ideally between 15 g/m² and 20 g/m² of wet product.

The printing machine must have a thermal dryer, typically composed of a ventilated air oven that reaches a temperature of around 180° C., at least 75° C. This starts the process of the gelation. According to a preferred embodiment, the paper length inside the dryer should be at least 2 meters, ideally more than 20 meters.

Afterwards a group of infrared lamps that brings the surface of the coating around 200° C. or more to complete the reticulation.

According to a preferred embodiment, the paper treated, which results in being a preferred composite coated article, in this way has its fibers crosslinked with Silica, getting important barriers to water, grease, oil and improving the oxygen barrier (OTR) and water vapor or moisture barrier (WVTR/MVTR) which are necessary for food conservation and allows the paper packaging to be competitive with plastic or plastic-coated packaging in terms of shelf life.

With particular types of cellulose-based substrate and preferably paper like glassine paper or other cellulosic support with a low-porosity: Ra (Confocal) below 4 μm. These barrier indicators are very close to plastic films and sometimes even better.

Preferably the contact angle measured on these glassine papers, after the coating described by the present invention, is above 150°. That means a strong potential application for beverage containers or so.

In an alternative form or manufacturing, the coating composition may further photocatalysts. These photocatalysts activate free radical polycondensation of the sol deposited on the cellulose-based substrate, preferably on paper.

This will allow to replace the thermal dryer with UV lamps, increasing the speed and reducing the energy consumption and vapors during the production of the composite coated article. This formulation is compatible with the majority of printing system machines (for example rotogravure, flexography, photogravure, inkjet, offset, lithography, pad printing, . . . ) or other methods (size-press, spraying . . . ) sheet-fed or web-fed.

Thanks to the coating layer of the coating composition, the paper advantageously displays water and oil repellency and other barrier properties. Moreover, even when it is folded, the folded portion experiences little, negligible, losses of water, oil or gas barrier. The paper sheet thus finds use in single-use packaging, primary, secondary or tertiary packaging, single-use products (cups, straws, forks, dishes, etc), food packages and wrappers including base paper and wrappers for chocolate and snacks, paper boxes and bags for fried potato, fried chicken, doughnuts, frozen food, crackers and cakes and wrappers for hamburgers and fried items, or for other non-food product such as belts, pens, paper, brushes, sponges, soaps, screws, telephones, plants, masks, and so on.

A further object of the invention is a method to prepare said coating composition to treat the above-mentioned substrates, preferably cellulose-based substrates, especially for packaging or single-use application, with high barrier properties against water (i.e. COBB or water contact angle), grease (i.e. kit), oxygen (i.e. OTR), water vapor (i.e. WVTR/MVTR), light or UV radiations, high resistance to heating (i.e. R-value).

This invention stands out from the prior art because the coating composition and the application procedures do not affect the printing of the substrate, particularly cellulose-based substrates. Furthermore, the application of the coating composition, according to the present invention, does not prevent the recycling of the substrate, especially when made of a cellulose matrix, and facilitates its adaptation to the industrial box making machines. On the other side, the application of this new coating composition is compatible with current printing and coating machines facilitating the adaptation preferably to current paper making and paper transformation industrial environment.

Preferably, a coated cellulose-based substrate, for example paper, can be used for primary, secondary or tertiary packaging as well as single-use applications, which includes methods of realization which solve the above-mentioned disadvantages and other limitations of the currently existing solutions.

### Composite Coated Article

According to a fourth aspect, the invention relates to a composite coated article comprising:
a first layer consisting of a substrate as described above, typically selected among cellulose-comprising substrates, metals or plastic substrates, preferably cellulose-comprising substrates, and
at least a second layer comprising the coating composition according to any one of the above embodiments.

In one embodiment, the composite coated article is obtainable or directly obtained by the coating of a substrate with the coating method of the invention.

In one embodiment, the composite coated article is a preliminary composite coated article.

In one embodiment, the composite coated article is a (dried) composite coated article. It should be understood that, the drying step (d) removes the dispersing agent of the coating composition. Accordingly, the composite coated article comprises:
a first layer consisting of a substrate as described above, typically selected among cellulose-comprising substrates, metals or plastic substrates, preferably cellulose-comprising substrates, and
at least a second layer comprising the coating composition of components A, B, and optionally C and/or D of the coating composition as described above.

The composite coated article of this invention is therefore able to retain inside or outside the packaging every liquid part (water, oil . . . ) avoiding any contamination or leaking.

The coating composition also adds an important gas barrier, improving the original properties of the paper—such as water vapor barrier (WVTR), moisture barrier (MTR) and oxygen barrier (OTR)—between 30% and 90%.

As previously mentioned, a preferred embodiment of the composite coated article comprises, as a substrate, preferably a cellulose-based substrate, most preferably paper. The composite coated article, based preferably on paper, has a higher resistance to heating, while remaining fully compatible with microwave ovens, combined with the original property of truly biodegradation and recyclability of the coated cellulosic support for primary, secondary or tertiary packaging or single-use applications (cups, straws, forks, dishes, etc).

In particular, the deposition on paper of the coating composition results in a viscous liquid coating, based preferably on silicon, hydroxide groups and further comprising a dispersion of organic, mineral or inorganic fillers (or particles). Preferably, this viscous liquid based on silica and made with technology, being the coating composition, once dried and reticulated, creates a covering layer preferably on the paper or cardboard and, more specifically, impregnates the paper or cardboard fibers to become completely chemically adherent to the cellulosic supports.

This chemically adherent layer of silicon based material, which is the so-called coating composition, is amorphous and inert, and is capable of rendering impermeable any coated substrate, preferably the cellulose-based substrate, even more preferably the coated paper, so that it can have a strong barrier to water, grease, oxygen, water vapor and UV light, as well as improving significantly the fire and heating resistance of the cellulosic support, while keeping all the typical recyclability and biodegradability properties of the cellulosic coated substrate.

The composite coated articles comprising cellulose-based substrate, preferably of paper or cardboard, can then be used (in webs or sheets) for packaging or other single use applications (see above). According to a preferred embodiment, some paper coated with this method, can reach a OTR (oxygen transfer rate) and WVTR (Water Vapor Transfer Rate) close or better than some plastic films, as well as other barrier indicators like Cobb (water absorbency) or much better than plastic films or other coated or uncoated papers like R-value (insulation—it is a value that is used to measure how well a specific type of insulation can resist heat flow). Such cellulose-based substrate, preferably coated papers or cardboards, can also be supplied (in webs or sheets) to converters for other types of application such as insulation, baking paper, thermoformed dishes, straws, or other disposable paper-based items.

Despite the application of the coating composition, the resulting coated paper is still recyclable, biodegradable and printable.

### Method for Preparing the Coating Composition

According to a fifth aspect, the invention relates to a method for preparing the coating composition according to any one the above embodiments, comprising
i. dispersing components (A), (B) and optionally (C) and/or (D) in the dispersing agent to obtain a mixture, and
ii. stirring the mixture obtained from step (i) until a viscosity of 5-5000 cps is obtained and until room temperature is reached, to obtain a coating composition.

A relaxed composition is formed by hydrolyzing and crosslinking the silane (A).

In one embodiment, step (i) comprises mixing component (A) with component (B), then optionally mixing with component (C) and/or (D), then dispersing the mixture thus obtained in the dispersing agent. In one embodiment, step (i) comprises mixing component (A) with component (C) and optionally with component (D), then mixing with component (B), then dispersing the mixture thus obtained in the dispersing agent.

The hydrolysis is an exothermal reaction which occurs when some or all of the alkoxy groups of the component (A) are transformed into hydroxyl groups by the catalyst (B); It should be noted that during the coating process, once applied onto the surface of a substrate from those listed above, these hydroxyl groups will polymerize and crosslink on such substrate, preferably the cellulose-based substrate, even more preferably the paper substrate, to give said composite coated article.

For the scope of this invention, room temperature (RT) is a temperature ranges from about 23° C. to about 30° C., preferably ranging from 25° C. to 27° C., even more preferably is equal to 25° C. For the same purposes, the expression “until the temperature returned normal” means until reaching room temperature.

The ingredients here above must be vigorously stirred, preferably by means of magnetic, rayneri, ultrasound or roto-stator methods.

The exothermal reaction of hydrolysis starts a few minutes or hours after starting to stir. The reaction is conducted until the room temperature is reached and until a viscosity of 5-5000 cps, preferably of 10-2000 cps, is obtained to produce an effective sol. This usually takes from about three hours to about two days, according to the room temperature and components quantities. It takes 4 h at 40° C. for 100 g final weight.

Unless otherwise specified, in the context of the present specification, the viscosity values are determined with the Standard Test Method for Kinematic Viscosity of Transparent and Opaque Liquids D445 method (D445-17a).

In one preferred embodiment of the invention, once the silane (A) of the coating composition has ripened and the hydrolysis occurred with (B), it is then mixed with (C), typically diluted in the dispersing agent. This addition will increase the viscosity, improving the adhesion to the coating cylinders and reducing the quantity of the needed coating composition. The preferred viscosity of the ripened coating composition ranges preferably from about 100 cps to about 5000 cps, preferably about 100 to about 1000 cps and most preferably is about 500 cps. The relaxed sol coating composition obtained has substantially no visible organic fillers or component (C) particles. The prior processes inherently produce coatings with visible particles and no significant improvement in oxygen transmission rate or water vapor transmission rate.

In another preferred embodiment of the invention, when component (B) includes organic fillers selected from the group consisting of: cellulose, microfibrillated cellulose, cellulose microcrystals, starch, chitin and mixtures thereof, such organic fillers of the component (C) can be added before the hydrolysis reaction starts. In this case, such organic fillers will be partially crosslinked with the mesh made by the auto-assembling hydroxyl groups. Organic fillers particles, preferably cellulose in form of powder or microfibrillated cellulose or cellulose microcrystals, have been added before the exothermal reaction of hydrolysis. The preferred viscosity ranges from about 100 cps to about 5000 cps, preferably about 100 to about 1000 cps and most preferably about 500 cps.

### EXAMPLES

The present invention is further illustrated by the following examples.

In the following examples a silane (A) is dissolved in a ethanol/water solution, the molar ratio of the silane to water to silica was varied from 20/10/1 to 20/9/2. The solution is hydrolyzed with concentrated Lewis acid, or HCl and a Lewis acid. Then the solution is allowed to age from 3 to 7 days depending on the initial reactants molar ratios to a viscosity of 2600 to 3200 cP (Brookfield #4 spindle @50 rpm). At that time the gel is diluted with a water/ethanol mixture or ethanol to a viscosity of 1-5 cP. Before coating down on 48 gauge PET a Lewis acid or a metal acetoacetonate (AcAc) is added. The coatings are laid down using either a #7, or #32 wire wound rod or dip coated. The samples are air dried.

### Example 1

A hydrolysis was carried out by mixing 1.5 grams of nanosized silica, 10 grams of water, 21.6 grams of trimethylethoxysilane and 0.1 gram of concentrated hydrochloric acid and 0.3 gram of a Lewis acid, FeCl3. The solution was stirred until the room temperature is reached and until the viscosity of the solution is 100-1000 cps, thus after approximately 18-24 hours. There were no visible signs of any particles in solution. The solution was visibly clear and had a viscosity of 10 cp. The solution was coated down onto 48-gauge paper film with a wire wound rod and hot air dried (75° C.). The thickness of the dried film is estimated to be 0.4 microns and SEM photomicrographs show no cracking of the film. The resultant oxygen transmission (OTR) rate at 0% Relative Humidity (RH) was 2000 cm³/m²/day, the water vapor transmission rate (WVTR) at 50% Relative Humidity (RH) 23° C. was 69 cm³/m²/day.

### Example 2

A hydrolysis was carried out by mixing 2.75 grams of nanosized silica, 10 grams of water, 21.6 grams of trimethylethoxysilane and 0.35 gram of a Lewis acid, FeCl3. The solution was stirred and until the temperature returned normal and viscosity of the solution is 10-100 cps, approximately 18-24 hours. There were no visible signs of any particles in solution. The solution was visibly clear and had a viscosity of 20 cps. The solution was coated onto a glassine paper, on both sides, with a wire wound rod and air dried (75° C.). The thickness of the dried film is estimated to be 0.6 microns and SEM photomicrographs show no cracking of the film after folding. The resultant oxygen transmission (OTR) rate at 0% Relative Humidity (RH) was 1500 cm³/m²/day, the water vapor transmission rate (WVTR) at 50% Relative Humidity (RH) 23° C. was 69 cm³/m²/day. The OTR improved by 82%, the WVTR improved by 51% compared to the uncoated samples.

### Example 3

A hydrolysis was carried out by mixing 2.75 grams of nanosized silica dispersed in 10 grams of water; 0.2 grams of cellulose dispersed in 5 grams of water with a surfactant (nonionic), 21.6 grams of trimethoxymethylsilane and 0.35 gram of a Lewis acid, FeCl3. The solution was stirred until the temperature returned normal and viscosity of the solution was 10-100 cps, approximately, within 18-24 hours of slow stirring. There were no visible signs of any particles in solution. The solution was visibly clear and had a viscosity of 20 cps. The solution was coated onto a glassine paper, on both sides, with a wire wound rod (120 lines per inch) and air dried (75° C.). The thickness of the dried film is estimated to be 0.6 microns and SEM photomicrographs show no cracking of the film after folding. The resultant oxygen transmission (OTR) rate at 0% Relative Humidity (RH) was 1500 cm³/m²/day, the water vapor transmission rate (WVTR) at 50% Relative Humidity (RH) 23° C. was 89 cm³/m²/day. The OTR improved by 82%, the WVTR improved by 51% compared to the uncoated samples.

This invention stands out from the previous ones, because the cellulosic-based substrate, when treated with the coating composition, is fully recyclable, maintaining the paper coarse reject after repulping below 5% and being compliant with the strictest regulations in the world.

### Example 4—Barriers Table

The samples for the barrier test were prepared by coating as described in table 1, on both planar surfaces of the paper. The samples were 92 gsm glassine paper sheets coated on both major surfaces. The barrier properties on oxygen, water vapor and grease barrier of the treated paper earlier mentioned produced by gravure printing of the Silicon based coating as described above.

TABLE 1
results of the barrier test

| | Value | | Method |
|---|---|---|---|
| OTR | <1 | cm³/m²/day | ASTM D3985 |
| WVTR | 8 | g/m²/day | ASTME-96 |

| | | |
|---|---|---|
| Grease barrier | 12 out of 12 | Tappi T 559 |

Oxygen transmission rate (OTR) was measured using the standard procedure based on ASTM D3985 (at 23° C., 0% relative humidity).

Water vapor transmission rate (WVTR) was measured gravimetrically using the standard procedure based on ASTME-96 (at 23° C., 50% relative humidity).

Grease barrier was measured using the T 559 Tappi−12=most aggressive solution to be applied.

1-14. (canceled)

15. A method for coating a cellulose-comprising substrate, comprising:
applying a coating composition on at least one surface of the cellulose-comprising substrate;
wherein the composition comprises:
(A) at least one silane selected from the group consisting of: vinyltrimethoxysilane, methyltrimethoxysilane, trimethoxysilane, methyltriethoxysilane, triethoxypropylsilane, thriethoxysilane, (3-Mercaptopropyl)trimethoxysilane, (3-Mercaptopropyl)triethoxysilane, 3-(Trimethoxysilyl)propyl methacrylate, 3-(Triethoxysilyl)propyl methacrylate, Glycidoxypropyltrimethoxysilane, Bis[3-(triethoxysilyl)propyl] tetrasulfide, 1,2-bis(triethoxysilyl)ethane, N-[3-(trimethoxysilyl)propyl] aniline, Aminopropyltriethoxysilane, Bis-[3-(triethoxysilyl)propyl] amine, Bis-[3-(trimethoxysilyl)propyl] amine, Triethoxyphenylsilane and trimethoxyphenylsilane, Trimethoxyvinylsilane, Triethoxyvinylsilane, vinyltrimethylsilane, chlorovinylsilane, chlorodimethylvinylsilane and mixtures thereof,
(B) from 0.01% to 3% by weight relative to the weight of the at least one silane of a catalyst selected from a monoprotic and/or a polyprotic acid,
and a dispersing agent selected from the group consisting of water and a hydroalcoholic solution comprising a linear or branched C1 to C4 alcohol and more than 55% by volume water relative to the volume of the dispersing agent.

16. The method according to claim 15, wherein the at least one silane is selected from the group consisting of methyltriethoxysilane, methyltrimethoxysilane trimethoxysilane, triethoxysilane and mixtures thereof.

17. The method according to claim 15, wherein the monoprotic acid is selected from the group consisting of: hydrochloric acid, nitric acid and acetic acid; and/or wherein the polyprotic acid is selected from the group consisting of: carbonic acid, sulfuric acid and citric acid.

18. The method according to claim 15, wherein the composition further comprises at least one Lewis acid selected from the group consisting of: sulfur trioxide, aluminum chloride, iron (III) chloride and zinc chloride.

19. The method according to claim 15, wherein the composition further comprises:
(C) from 0.30% to 50% by weight relative to the weight of the at least one silane of a filler composition comprising:
c1) at least one inorganic filler selected from the group consisting of silicon dioxide, aluminum oxides, phyllosilicates, inosilicates, tectosilicates, talcum powder, zinc sulphate, magnesium, oxide, zinc flakes, talc, kaolin, albarine, dolomite, cerium oxide, magnesium carbonate, calcium carbonate, sodium aluminate, calcium sulphate, barium sulphate, zinc stearate, and a mixture thereof;
and/or
c2) at least one organic filler selected from the group consisting of cellulose, microfibrillated cellulose, nanofibrillated cellulose, cellulose microcrystals, starch, chitin and a mixture thereof.

20. The method according to claim 15, wherein the composition further comprises from more than 0% to 1.5% by weight relative to the weight of the at least one silane of an organopolysiloxane (D) presenting alkyl chains with a number of carbon atoms C ranging from C7 to C18, and alkoxy groups.

21. The method according to claim 15, wherein the monoprotic acid is hydrochloric acid.

22. The method according to claim 18, wherein the at least one Lewis is iron (III) chloride.

23. The method according to claim 19, wherein the inorganic filler is silicon dioxide.

24. A coating composition, comprising:
(A) at least one silane selected from the group consisting of: triethoxypropylsilane, methyltriethoxysilane, methyltrimethoxysilane, trimethoxysilane, triethoxysilane, and mixtures thereof,
(B) from 0.01% to 3% by weight relative to the weight of the at least one silane of a catalyst selected from a monoprotic and/or a polyprotic acid,
and a dispersing agent selected from the group consisting of water and a hydroalcoholic solution comprising a linear or branched C1 to C4 alcohol and more than 55% by weight water relative to the weight of the dispersing agent.

25. The coating composition according to claim 24, further comprising:
(C) from 0.30% to 10% by weight relative to the weight of the at least one silane of a filler composition comprising:
c1) an inorganic filler composition comprising at least one inorganic filler selected from the group consisting of silicon dioxide, aluminum oxides, phyllosilicates, inosilicates, tectosilicates, talcum powder, zinc sulphate, magnesium, oxide, zinc flakes, talc, kaolin, albarine, dolomite, cerium oxide, magnesium carbonate, calcium carbonate, sodium aluminate, calcium sulphate, barium sulphate, zinc stearate, and a mixture thereof;
and/or
c2) an organic filler composition comprising at least one organic filler selected from the group consisting of cellulose, microfibrillated cellulose, nanofibrillated cellulose, cellulose microcrystals, starch, chitin and a mixture thereof.

26. The coating composition according to claim 24, said composition comprising:
(A) at least one silane selected from the group consisting of: triethoxypropylsilane, methyltriethoxysilane, methyltrimethoxysilane, trimethoxysilane, triethoxysilane, in an amount ranging from 40% to 80% w/w in weight relative the total weight of the coating composition, and
(B) a catalyst selected from a monoprotic and/or a polyprotic acid, in an amount ranging from 0.01% to 1% w/w in weight relative to the weight of the at least one silane.

27. The coating composition according to claim 25, wherein the organic filler is selected from the group consisting of microfibrillated cellulose, nanofibrillated cellulose and a mixture thereof.

28. The coating composition according to claim 26, said composition further comprising a filler composition (C) selected from:
c1) silicon dioxide in an amount ranging from 0.30% to 5.0% w/w in weight relative to the weight of the at least one silane,
and/or
c2) microfibrillated and/or nanofibrillated cellulose in an amount ranging from 0.30% to 5.0% w/w in weight relative to the weight of the at least one silane.

29. A composite coated article comprising:
a first layer consisting of a substrate selected from the group consisting of cellulose-comprising substrates, metals or plastic substrates
at least a second layer comprising a coating composition comprising:
(A) at least one silane selected from the group consisting of: triethoxypropylsilane, methyltriethoxysilane, methyltrimethoxysilane, trimethoxysilane, triethoxysilane, and mixtures thereof,
(B) from 0.01% to 3% by weight relative to the weight of the at least one silane of a catalyst selected from a monoprotic and/or a polyprotic acid,
and a dispersing agent selected from the group consisting of water and a hydroalcoholic solution comprising a linear or branched C1 to C4 alcohol and more than 55% by weight water relative to the weight of the dispersing agent.

30. The composite coated article according to claim 29, wherein the first layer consists of a cellulose-comprising substrate.

31. The composite coated article according to claim 30, wherein the cellulose-comprising substrate is selected from the group consisting of: paper, treated paper, glassine paper, cardboard, cellulosic support, low-porous cellulosic support and wood.

32. A method for coating a substrate, comprising the steps of:
a) providing a substrate selected among cellulose-comprising substrates, metals or plastic substrates,
b) preparing a coating composition,
c) applying the coating composition on at least one surface of the substrate to obtain a preliminary composite coated article, and
d) drying the preliminary composite coated article at a temperature ranging from 20° C. for several days to 280° C. for less than 1 minute, to obtain the composite coated article
wherein the coating composition comprises:
(A) at least one silane selected from the group consisting of: triethoxypropylsilane, methyltriethoxysilane, methyltrimethoxysilane, trimethoxysilane, triethoxysilane, and mixtures thereof,
(B) from 0.01% to 3% by weight relative to the weight of the at least one silane of a catalyst selected from a monoprotic and/or a polyprotic acid,
and a dispersing agent selected from the group consisting of water and a hydroalcoholic solution comprising a linear or branched C1 to C4 alcohol and more than 55% by weight water relative to the weight of the dispersing agent.

33. A method for preparing a coating composition comprising:
(A) at least one silane selected from the group consisting of: triethoxypropylsilane, methyltriethoxysilane, methyltrimethoxysilane, trimethoxysilane, triethoxysilane, and mixtures thereof,
(B) from 0.01% to 3% by weight relative to the weight of the at least one silane of a catalyst selected from a monoprotic and/or a polyprotic acid,
a dispersing agent selected from the group consisting of water and a hydroalcoholic solution comprising a linear or branched C1 to C4 alcohol and more than 55% by weight water relative to the weight of the dispersing agent, and
(C) optionally from 0.30% to 10% by weight relative to the weight of the at least one silane of a filler composition comprising
c1) an inorganic filler composition comprising at least one inorganic filler selected from the group consisting of silicon dioxide, aluminum oxides, phyllosilicates, inosilicates, tectosilicates, talcum powder, zinc sulphate, magnesium, oxide, zinc flakes, talc, kaolin, albarine, dolomite, cerium oxide, magnesium carbonate, calcium carbonate, sodium aluminate, calcium sulphate, barium sulphate, zinc stearate, and a mixture thereof;
and/or
c2) an organic filler composition comprising at least one organic filler selected from the group consisting of cellulose, microfibrillated cellulose, nanofibrillated cellulose, cellulose microcrystals, starch, chitin or a mixture thereof;
said method comprising the steps of:
(i) dispersing components (A), (B) and optionally (C) in the dispersing agent to obtain a mixture, and
(ii) stirring the mixture obtained from step (i) until a viscosity of 5-5000 cps is obtained and until room temperature is reached, to obtain the coating composition.
